(19) United States
(12) Patent Application Publication
(10) Pub. No.: US 2017/0244233 A1
(43) Pub. Date: Aug. 24, 2017

(54) CABLE RETAINER ASSEMBLY

(71) Applicant: Wanho T Manufacturing Co., Ltd., llan (TW)

(72) Inventors: Wan Chang HSU, llan (TW); David Robert ELLIOTT, Southington, CT (US)

(21) Appl. No.: 15/047,661

(22) Filed: Feb. 19, 2016

(51) Int. Cl. H02G 3/32; H01R 13/74

(52) U.S. Cl. CPC H02G 3/32; H01R 13/745

(57) ABSTRACT

A cable retainer assembly includes a base support device having an opening, and a clip device having a base plate and two side plates folded from the base plate for clamping a cable between the side plates, the side plates each include one or more grooves for forming a flap in each of the side plates and for engaging the flaps of the side plates into the opening of the base support device, and for attaching the clip device to the base support device. The side plates of the clip device each include a curved portion directed toward each other for forming a chamber between the curved portions of the side plates and for engaging with the cable.

### BACKGROUND OF THE INVENTION

1. Field of the Invention

The present invention relates to a cable retainer assembly, and more particularly to a cable retainer assembly including an improved structure or configuration for solidly and stably clamping and retaining the cable in position and for preventing the cable from being moved and disengaged or separated from the cable retainer assembly.

2. Description of the Prior Art

Various kinds of typical cable retainer assembly assemblies have been developed and provided for clamping and retaining cables, such as electrical cables, optical cables etc. for signal transmitting purposes, and comprise two or more pieces or elements for clamping and retaining the cables in place.

For example, U.S. Pat. No. 7,824,213 to Korcz et al., U.S. Pat. No. 8,413,416 to Egami, and U.S. Pat. No. 9,106,069 to Frizzell disclose several of the typical cable retainer assembly assemblies developed and provided for clamping and retaining cables and the like, and/or for attaching the cables to the supporting members.

However, the typical cable retainer assembly assemblies normally include a complicated structure or configuration that may not be easily and quickly made or manufactured and that may include a complicated making or manufacturing procedure and that may include a greatly increased manufacturing cost.

The present invention has arisen to mitigate and/or obviate the afore-described disadvantages of the conventional cable retainer assembly assemblies or retaining devices.

### SUMMARY OF THE INVENTION

The primary objective of the present invention is to provide a cable retainer assembly including an improved structure or configuration for solidly and stably clamping and retaining the cable in position and for preventing the cable from being moved and disengaged or separated from the cable retainer assembly.

In accordance with one aspect of the invention, there is provided a cable retainer assembly comprising a base support device including an opening formed therein, and a clip device including a base plate and two side plates folded and extended from the base plate for clamping a cable between the side plates, the side plates each including at least one groove formed therein for forming a flap in each of the side plates, and for engaging and hooking the flaps of the side plates into the opening of the base support device, and for quickly attaching and mounting the clip device to the base support device and for preventing the clip device from being moved and disengaged or separated from the base support device.

The side plates of the clip device each include a curved portion formed therein, and the curved portions of the side plates are directed toward each other for forming a chamber between the curved portions of the side plates and for resiliently receiving and engaging with the cables of different diameters or standards or shapes or the like.

The side plates of the clip device each include at least one projection extended from the curved portion of the side plate and extended into the chamber of the clip device for frictionally engaging with the cable and for stably retaining the cable to the clip device and for preventing the cable from slipping or moving relative to the clip device.

The side plates of the clip device each include a slit formed therein for selectively engaging with a strap or the like. The clip device includes an orifice formed in the base plate for selectively engaging with the flaps of the other clip device and for allowing two or more clip devices to be easily and quickly coupled to each other. The side plates of the clip device each include an outwardly curved flange for firmly and stably engaging with and anchoring to the other clip device.

The flaps each include a curved segment provided therein for increasing a resilience of the flaps. The flaps each include an outwardly curved ear for engaging with the opening of the base support device. The flaps each include at least one fin extended from the ear.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a cable retainer assembly in accordance with the present invention;

FIG. 2 is another exploded view illustrating the operation of the cable retainer assembly;

FIG. 3 is a partial cross sectional view illustrating the operation of the cable retainer assembly;

FIG. 4 is a partial perspective view illustrating a clip device of the cable retainer assembly;

FIGS. 5, 6, 7, 8 are top plan schematic views illustrating the operation of the cable retainer assembly;

FIG. 9 is a perspective view illustrating the other arrangement of the cable retainer assembly;

FIG. 10 is an exploded view of the cable retainer assembly as shown in FIG. 9;

FIG. 11 is a further exploded view illustrating the further arrangement of the cable retainer assembly;

FIG. 12 is a partial cross sectional view of the cable retainer assembly as shown in FIG. 11;

FIG. 13 is a still further exploded view illustrating the further arrangement of the cable retainer assembly;

FIG. 14 is a partial cross sectional view of the cable retainer assembly as shown in FIG. 13;

FIG. 15 is a still further exploded view illustrating the further arrangement of the cable retainer assembly;

FIG. 16 is a partial cross sectional view of the cable retainer assembly as shown in FIG. 15;

FIG. 17 is a perspective view illustrating the cable retainer assembly as shown in FIGS. 15, 16;

FIG. 18 is an enlarged partial perspective view of the cable retainer assembly as shown in FIGS. 15-17; and

FIGS. 19, 20 are partial front plan schematic views illustrating the operation of the cable retainer assembly.

### DETAILED DESCRIPTION OF THE PREFERRED EMBODIMENT

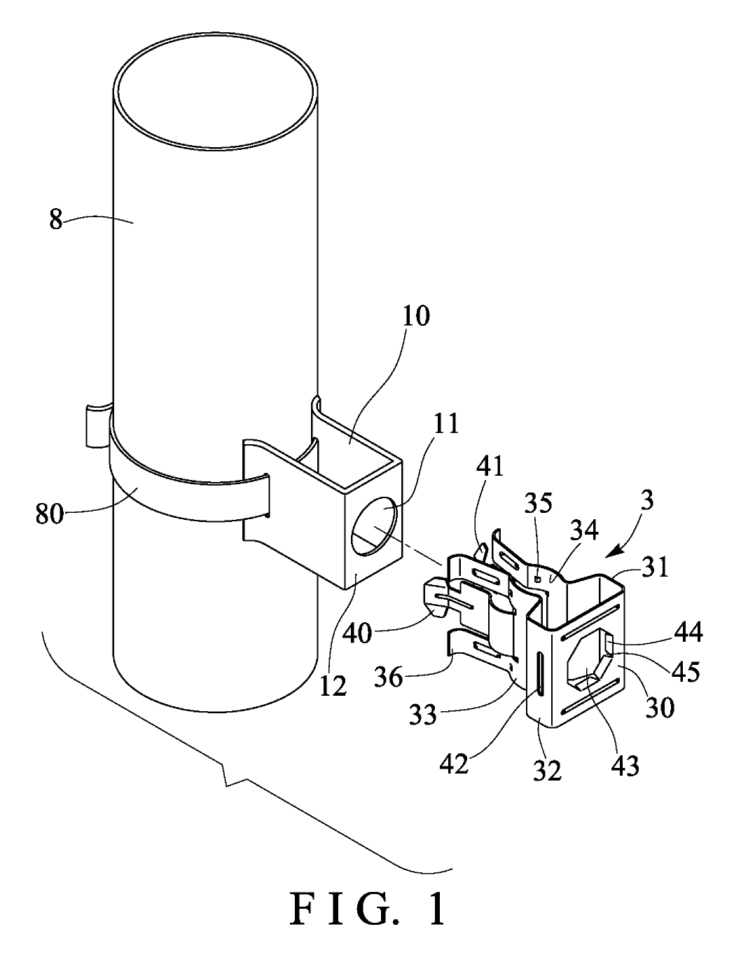

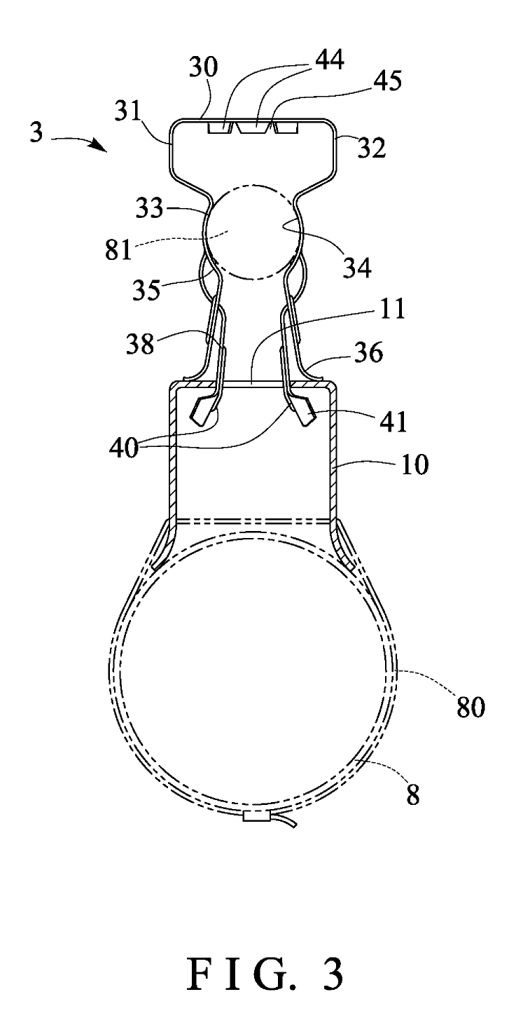

Referring to the drawings, and initially to FIGS. 1-6, a cable retainer assembly in accordance with the present invention comprises a base support device 10 including a bore or opening 11 formed therein, for example, the base support device 10 may include a spatial or three-dimensional or parallelepiped structure or configuration having the opening 11 formed in one of the surfaces 12 thereof, the base support device 10 may further be attached or mounted or secured or coupled to the other supporting members or facilities 8, such as a tubular member 8 with screws or bolts or catches or latches or fasteners or straps 80 or the like.

The cable retainer assembly further includes a clip device 3 also having a substantially spatial or three-dimensional or parallelepiped structure or configuration, the clip device 3 includes a front or base plate 30 and two side plates 31, 32 folded or extended from the base plate 30 and substantially perpendicular to the base plate 30 for forming the substantially spatial or three-dimensional or parallelepiped structure or configuration, and the side plates 31, 32 each include a curved portion 33 formed or provided therein, and the curved portions 33 of the side plates 31, 32 are located or faced or directed toward each other for forming or defining a substantially circular chamber 34 therein and between the curved portions 33 of the side plates 31, 32.

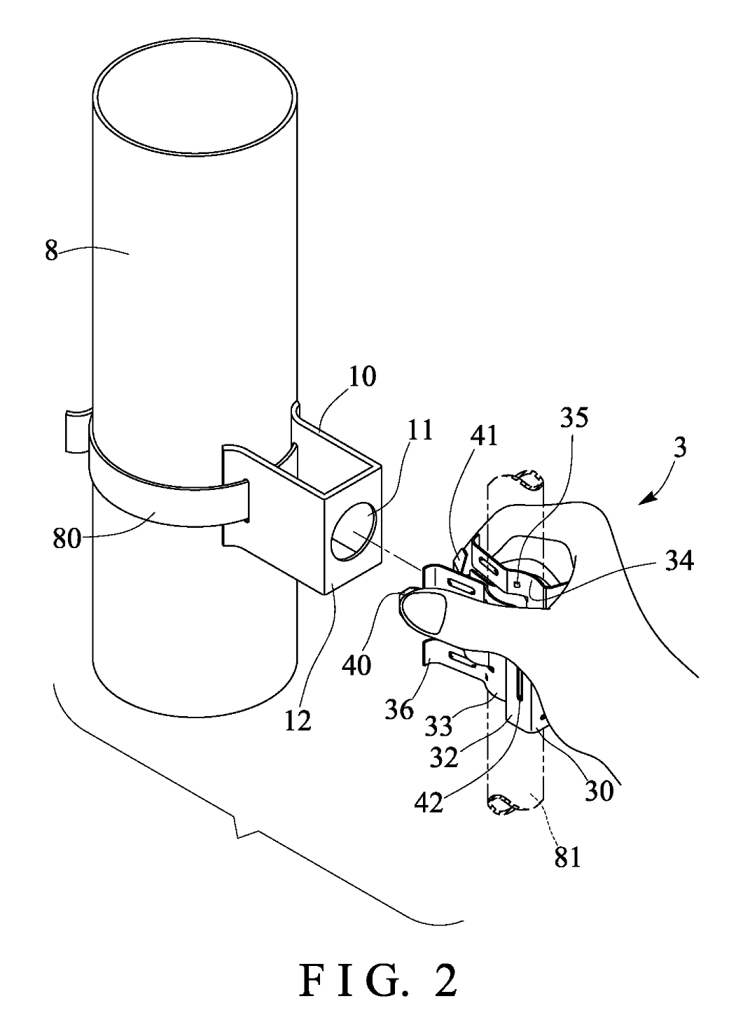

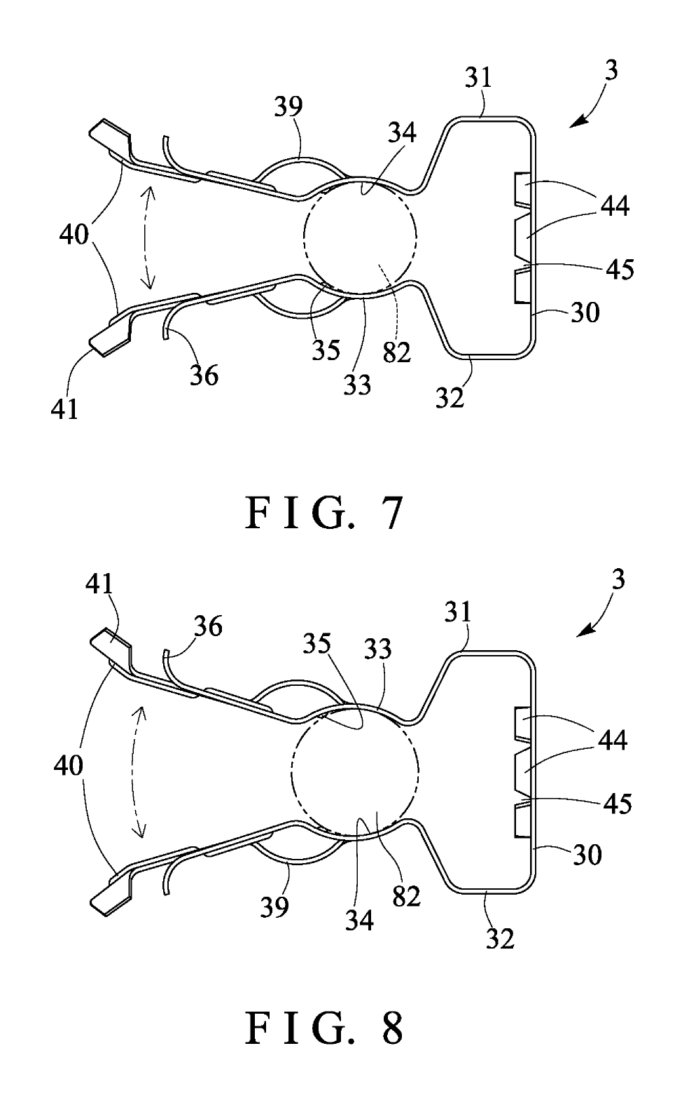

As shown in FIGS. 2-4 and 6-8, the cables 81, 82, 83 of different outer diameters may be resiliently and solidly and stably clamped and retained in position within the chamber 34 of the clip device 3 and between the resilient side plates 31, 32. The clip device 3 may further include one or more pegs or projections 35 extended from the curved portions 33 of the side plates 31, 32 and extended into the chamber 34 of the clip device 3 for contacting or engaging with the cables 81, 82, 83 and for further solidly and stably positioning and retaining the cables 81, 82, 83 within the chamber 34 of the clip device 3.

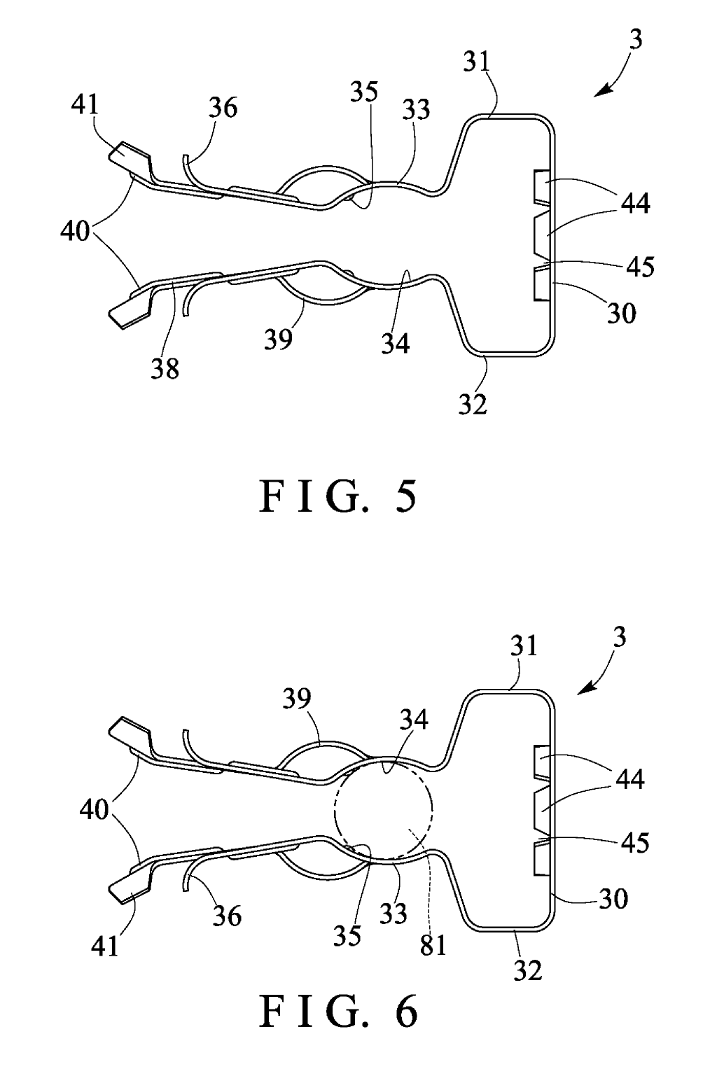

As best shown in FIGS. 5-8, the side plates 31, 32 of the clip device 3 each include an outwardly rounded or curved flange 36 for guiding the cables 81, 82, 83 to easily engage into the chamber 34 of the clip device 3, and each further include one or more (such as two) slots or grooves 37 longitudinally formed therein and substantially parallel to the side plates 31, 32 and/or substantially perpendicular to the base plate 30 for forming or defining a resilient flap 38 in each of the side plates 31, 32. It is preferable that the flaps 38 each include a curved member or segment 39 formed or provided therein for suitably increasing the resilience of the flaps 38.

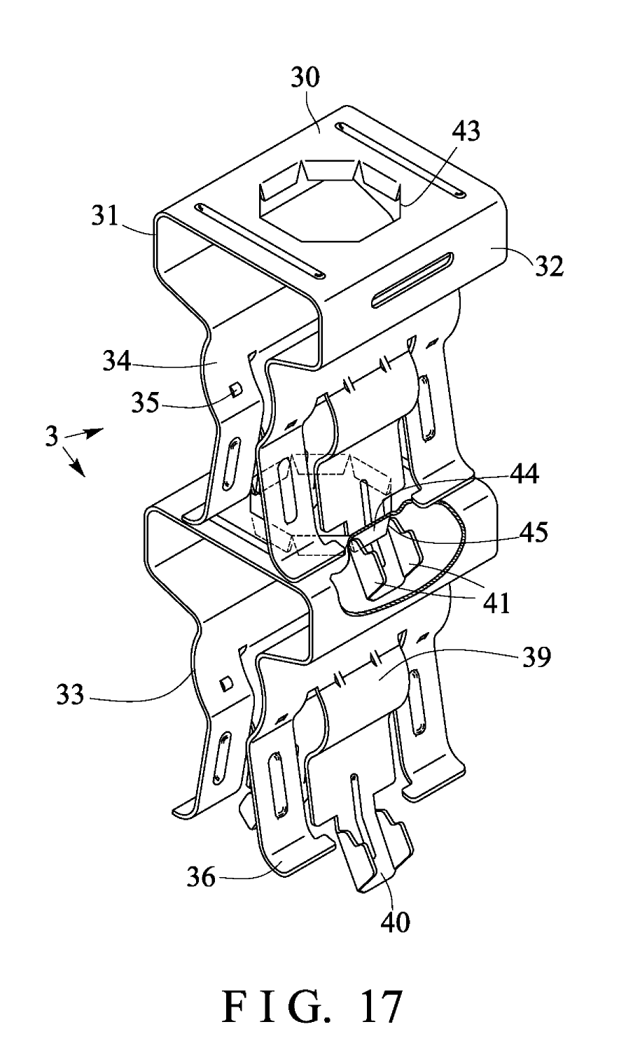

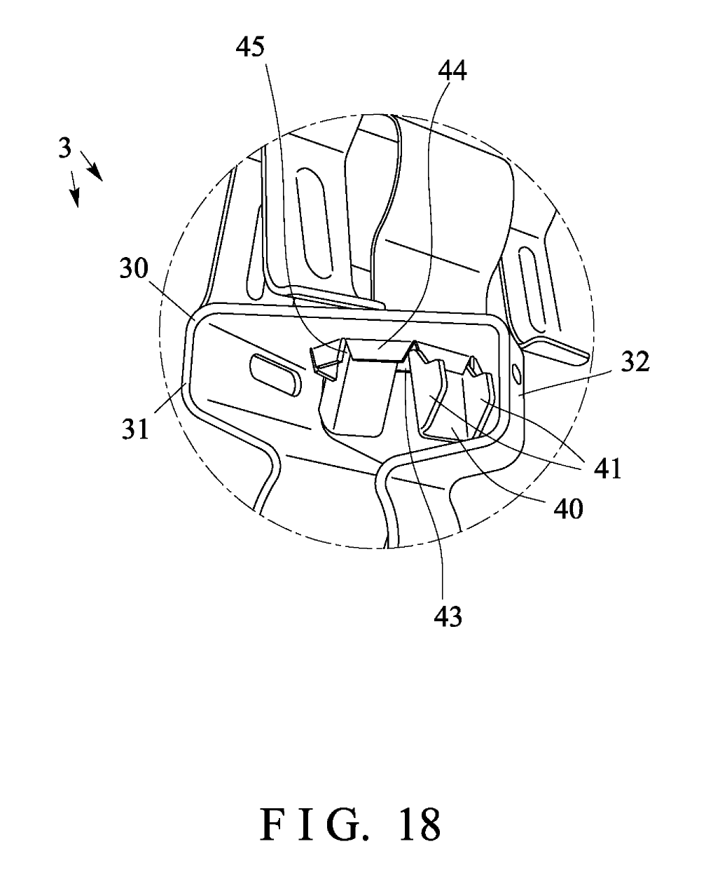

The flaps 38 each further include an outwardly rounded or curved hook or end ear 40 for engaging with the opening 11 of the base support device 10 and for resiliently hooking or attaching or mounting to the base support device 10. It is preferable that the flaps 38 each further include one or more outwardly extended and rounded or curved fins 41 folded or extended from the respective ear 40 for guiding the flaps 38 to easily engage into the opening 11 of the base support device 10 and for contacting or engaging with the base support device 10 and/or the other base plate 30 (FIGS. 17-18), and/or for allowing the flaps 38 to be easily and comfortably grasped and held by the user and/or for allowing the flaps 38 to be easily engaged into the opening 11 of the base support device 10 by the user (FIG. 2).

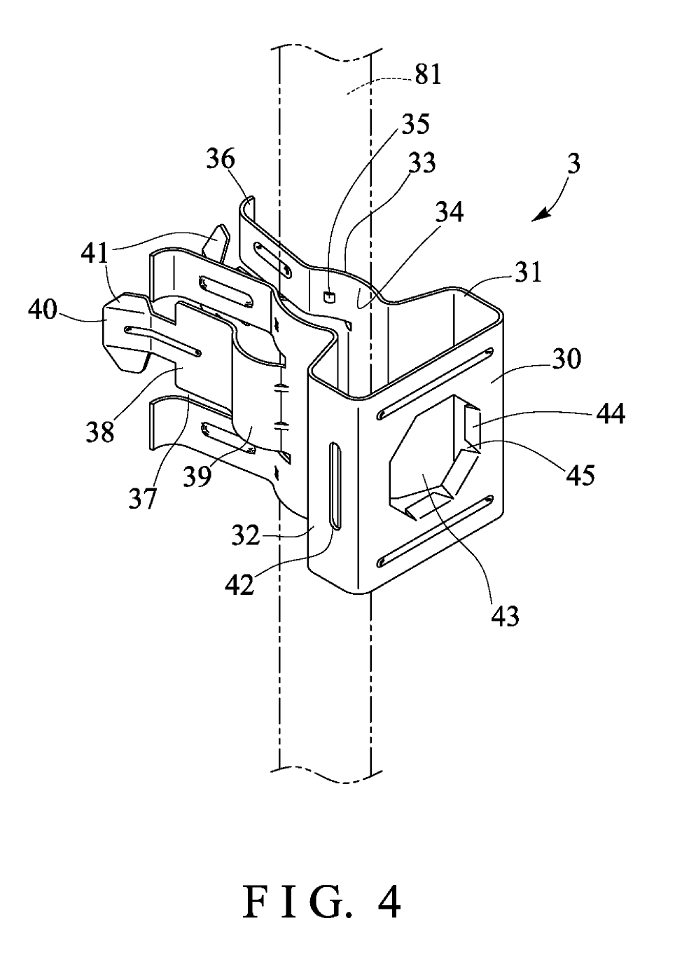

In operation, as shown in FIGS. 4-8, the cables 81, 82, 83 of different outer diameters may be easily and quickly engaged into the chamber 34 of the clip device 3 and resiliently and solidly and stably clamped and retained in position with the resilient side plates 31, 32. As shown in FIG. 2, the flaps 38 may then be easily engaged into the opening 11 of the base support device 10 by the user for easily and quickly and resiliently hooking or attaching or mounting the clip device 3 to the base support device 10, without additional tools and fasteners.

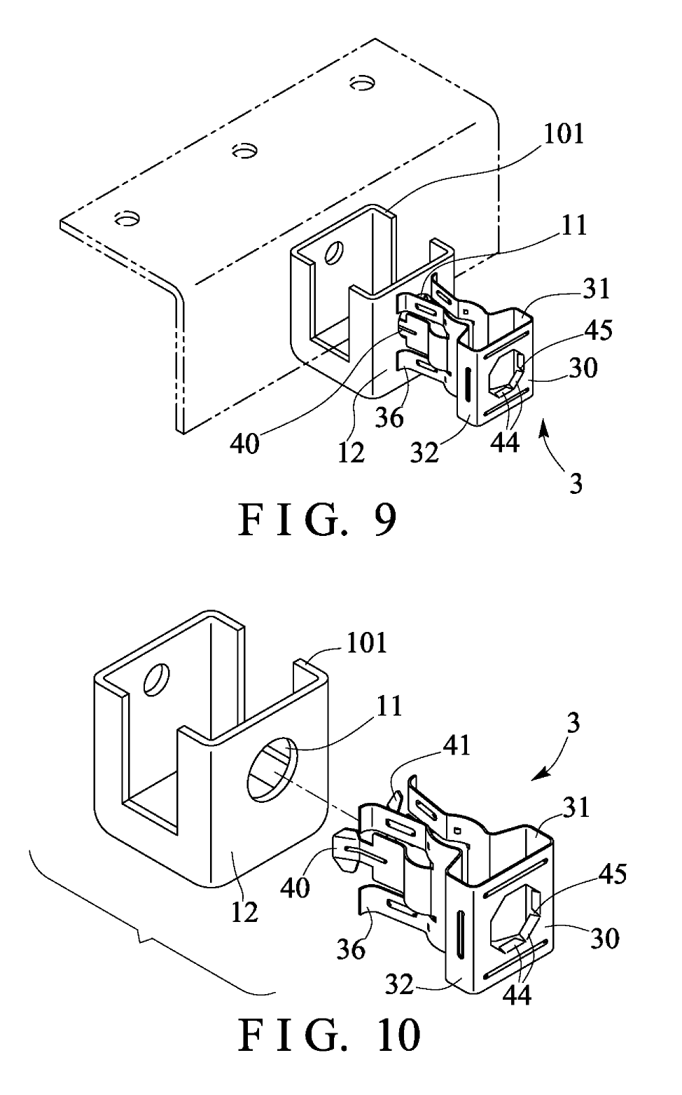

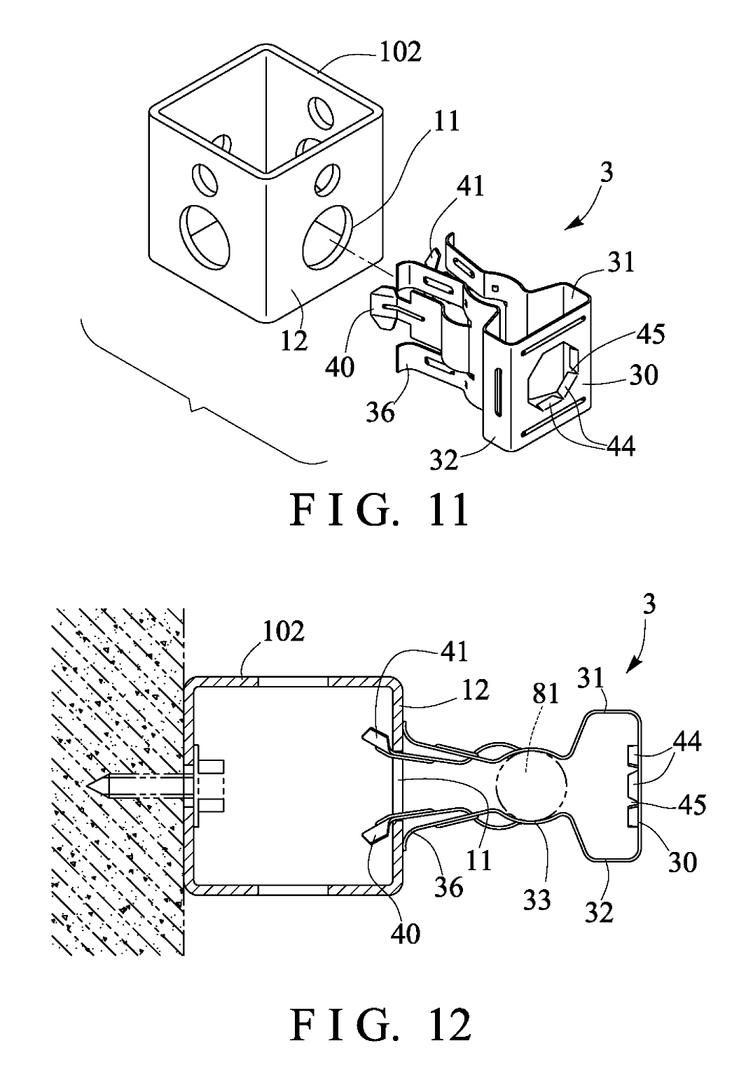

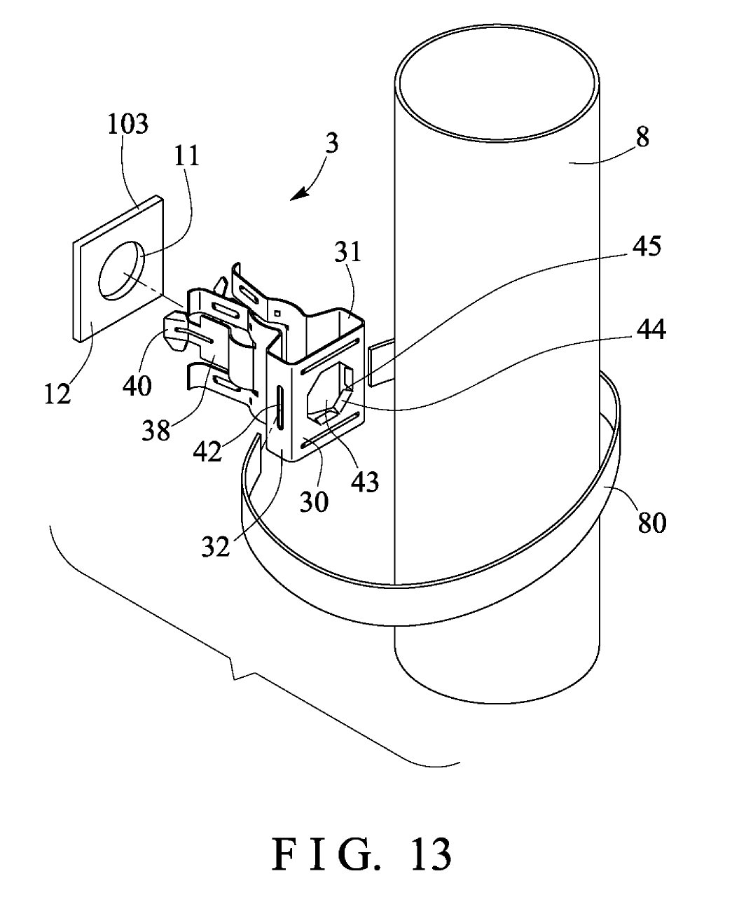

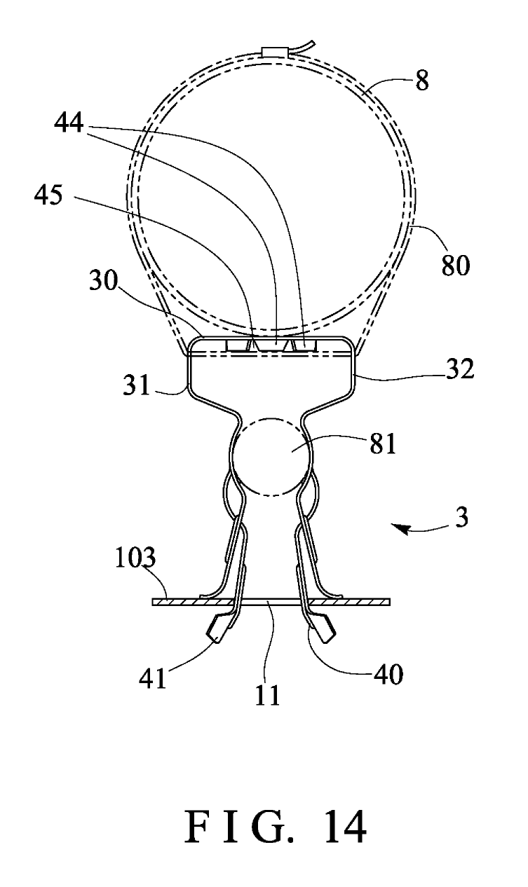

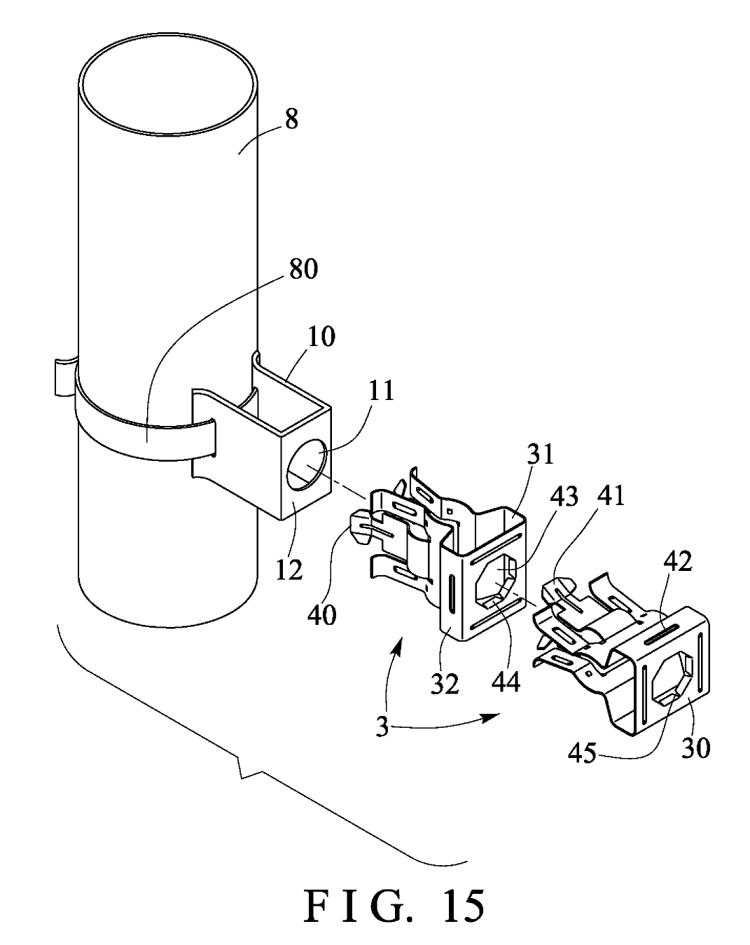

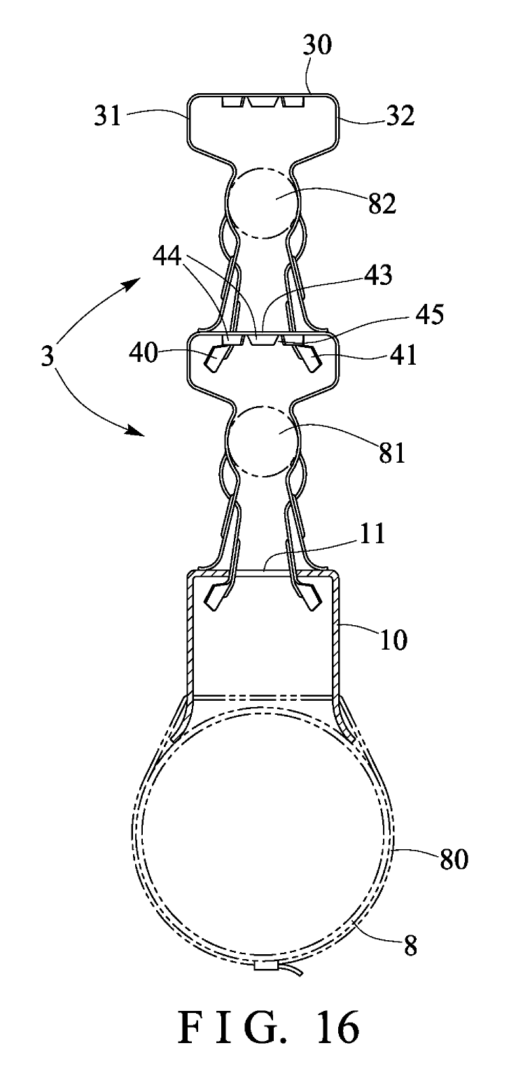

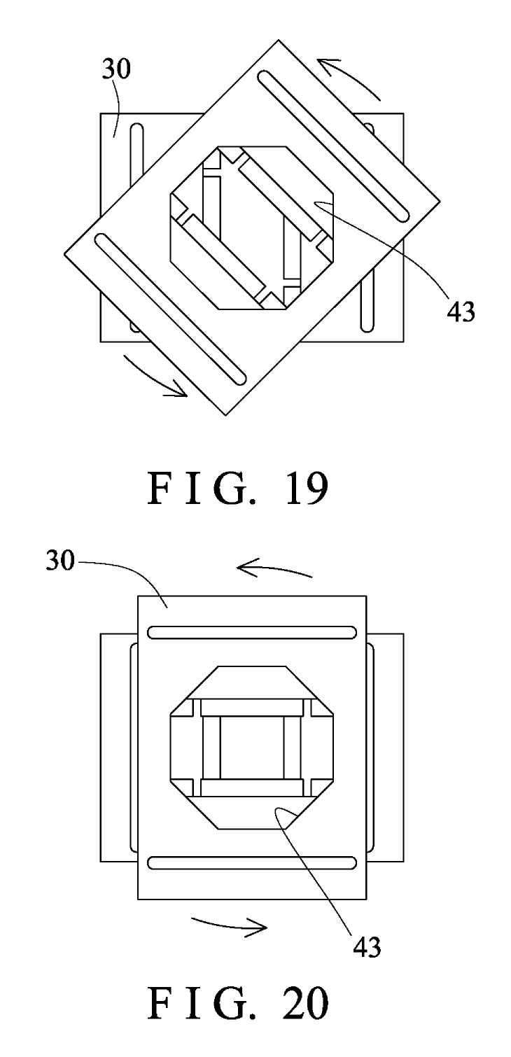

As shown in FIGS. 9-14, the base support device 101, 102, 103 may be formed into the other shapes or structures or configurations and may also include the opening 11 formed in one of the surfaces 12 thereof for receiving or engaging with the outwardly curved hooks or ears 40 of the flaps 38 of the side plates 31, 32. As shown in FIGS. 1-2, 4 and 13-14, the clip device 3 may further include one or more slits 42 formed in each of the side plates 31, 32 for selectively engaging with the straps 80 or the like. As shown in FIGS. 1, 4, 13 and 15-20, the clip device 3 may further include an orifice 43 formed therein, such as formed in the base plate 30 thereof for selectively engaging with the outwardly curved hooks or ears 40 of the flaps 38 of the side plates 31, 32 of the other clip device 3. It is preferable that the orifice 43 of the clip device 3 may include an octangular structure or configuration having one or more (such as eight) folds or lips 44 extended from the base plate 30 and located around the orifice 43 of the clip device 3 and formed or defined between gaps or slots 45 for allowing the flaps 38 to be pivoted or rotated or adjusted relative to the other clip device 3 or relative to the base support device 10. The fins 41 of the flaps 38 may be solidly and stably engaged with the lips 44 and/or the slots 45 of the clip device 3 (FIGS. 17-18) for allowing two or more clip devices 3 to be easily and quickly coupled to and anchored and positioned with each other.

Accordingly, the cable retainer assembly in accordance with the present invention includes an improved structure or configuration for solidly and stably clamping and retaining the cable in position and for preventing the cable from being moved and disengaged or separated from the cable retainer assembly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cable retainer assembly comprising:
a base support device including an opening formed therein, and
a clip device including a base plate and two side plates folded and extended from said base plate for clamping a cable between said side plates, said side plates each including at least one groove formed therein for forming a flap in each of said side plates, and for engaging said flaps of said side plates into said opening of said base support device, and for attaching said clip device to said base support device.

2. The cable retainer assembly as claimed in claim 1, wherein said side plates of said clip device each include a curved portion formed therein, and said curved portions of said side plates are directed toward each other for forming a chamber between said curved portions of said side plates and for engaging with said cable.

3. The cable retainer assembly as claimed in claim 2, wherein said side plates of said clip device each include at least one projection extended from said curved portion of said side plate and extended into said chamber of said clip device for engaging with said cable.

4. The cable retainer assembly as claimed in claim 1, wherein said side plates of said clip device each include a slit formed therein.

5. The cable retainer assembly as claimed in claim 1, wherein said clip device includes an orifice formed in said base plate.

6. The cable retainer assembly as claimed in claim 5, wherein said orifice of said base plate include an octangular structure.

7. The cable retainer assembly as claimed in claim 6, wherein said base plate include eight lips extended from the base plate and located around the orifice the clip device and formed between slots.

8. The cable retainer assembly as claimed in claim 1, wherein said side plates of said clip device each include an outwardly curved flange.

9. The cable retainer assembly as claimed in claim 1, wherein said flaps each include a curved segment provided therein for increasing a resilience of said flaps.

10. The cable retainer assembly as claimed in claim 1, wherein said flaps each include an outwardly curved ear for engaging with said opening of said base support device.

11. The cable retainer assembly as claimed in claim 10, wherein said flaps each include at least one fin extended from said ear.
